(19) United States
(12) Patent Application Publication
(10) Pub. No.: US 2012/0139267 A1
(43) Pub. Date: Jun. 7, 2012

(54) CUSHION STRUCTURE OF LOCK

(76) Inventor: Te-Yu Chen, Pingtung City (TW)

(21) Appl. No.: 12/960,558

(22) Filed: Dec. 6, 2010

(51) Int. Cl. E05C 3/30

(52) U.S. Cl. 292/56

(57) ABSTRACT

A cushion structure of lock includes a knob axle, a constraining member, a push bar, and a fixing member. The knob axle forms at one end thereof a pin, which is received in a slot defined in a casing of a lock, and also forms at an opposite end thereof an engagement section, which is positioned in engagement with the push bar. The constraining member is coupled to the push bar and has a surface forming an opening through which a positioning bar fixed to the casing is received. Springs are respectively arranged at a bottom of the constraining member and between the push bar and the fixing member. When the knob is operated to retract the latch bolt, the resiliency of the springs helps driving the constraining member and the knob axle so as to make the rotation of the knob easy and effortless.

### (a) TECHNICAL FIELD OF THE INVENTION

The present invention generally relates to a cushion structure of lock, and more particularly to a cushion structure of lock that makes the operation of lock knob effortless.

### (b) DESCRIPTION OF THE PRIOR ART

A door lock that is used in a door often comprises a primary bolt, a latch bolt, and a secondary bolt and also comprises a door knob. Normally, the door knob is rotatable to unlock the lock. The rotation of the knob causes the movements of a number of lock components and thus, a sufficient effort is needed in rotating the door knob. This may sometimes present a difficult to the elder or the physically weak people and makes the operation of door lock troublesome. In view of such a problem, it is desired to provide a structure that help overcoming the problem of operating a door know with sufficient effort and making the operation of door lock easy and effortless.

### SUMMARY OF THE INVENTION

The primary purpose of the present invention is to provide a cushion structure of lock that makes the operation of knob of lock easy and effortless.

According to the present invention, the cushion structure of lock comprises a knob axle, a constraining member, a push bar, and a fixing member. The knob axle forms at one end thereof a pin, which is received in a slot defined in a casing of a lock, and also forms at an opposite end thereof an engagement section, which is positioned in engagement with the push bar. The constraining member is coupled to the push bar and has a surface forming an opening through which a positioning bar fixed to the casing is received. Springs are respectively arranged at a bottom of the constraining member and between the push bar and the fixing member. When the knob is operated to retract the latch bolt, the resiliency of the springs helps driving the constraining member and the knob axle so as to make the rotation of the knob easy and effortless.

The cushion structure of lock further comprises a hook member, which is partly received in and coupled to a receiving groove defined in the latch bolt, whereby when the constraining member slides downward, the hook member is caused to move the latch bolt rearward so as to unlock the lock.

The foregoing objectives and summary provide only a brief introduction to the present invention. To fully appreciate these and other objects of the present invention as well as the invention itself; all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side elevational view showing the present invention.

FIG. 2 is a perspective view showing the present invention.

FIG. 3 demonstrates a locking operation of the present invention.

FIG. 4 demonstrates an unlocking operation of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

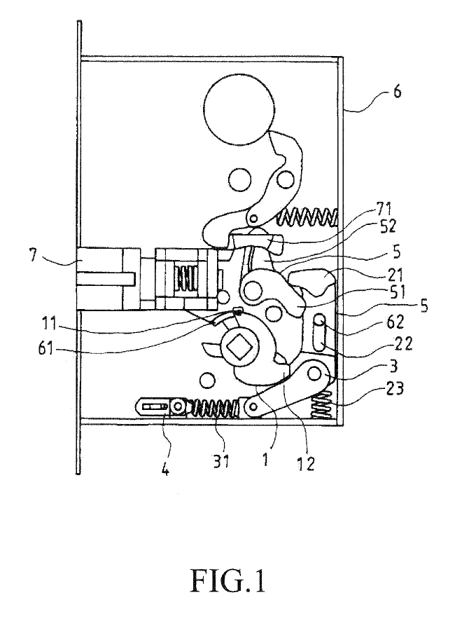

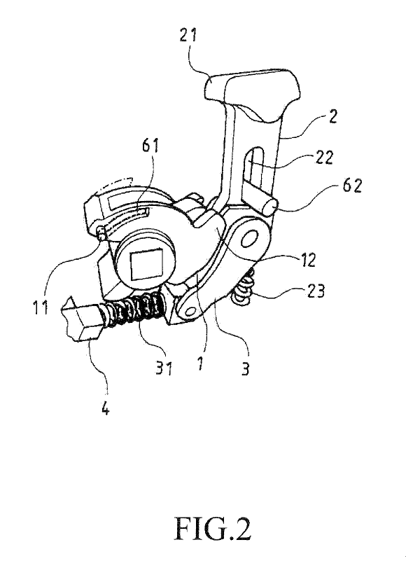

Referring to FIGS. 1 and 2, which are respectively a side elevational view and a perspective view of the present invention, the present invention comprises a knob axle 1, a constraining member 2, a push bar 3, and a fixing member 4, a hook member 5. The knob axle 1 forms at one end thereof a pin 11, which is received in a slot 61 defined in a casing 6 of a lock, and also forms at an opposite end thereof an engagement section 12, which is positioned in engagement with the push bar 3.

The constraining member 2 has a top forming a projection 21, a surface forming an opening 22, through which a positioning bar 62 fixed to the casing 6 is received, and a bottom to which a spring 23 is mounted.

The push bar 3 is coupled to the constraining member 2 at one end and has an opposite end to which a spring 31 is mounted. An opposite end of the spring 31 is fixed by the fixing member 4.

The hook member 5 comprises a first hook 51 and a second hook 52. The first hook 51 is received in and coupled to a receiving groove 71 formed in a latch bolt 7. The second hook 52 is set in engagement with the projection 21 formed on the top of the constraining member 2.

With the above discussed components properly assembled together, a cushion structure of lock is formed. When the knob axle 1 is rotated in a direction to retract the latch bolt 7 for unlocking, the engagement section 12 depresses the push bar 3 down, and the constraining member 2 is thus caused to slide downward, making the projection 21 formed on the top of the constraining member 2 driving the second hook 52 of the hook member 5 to rotate the hook member 5 by a predetermined angle so that the second hook 51 moves the latch bolt 7 rearward to unlock the lock. During the whole process, the resiliency of the springs 23, 31 provides a cushioning effect to the knob axle 1 so that the rotation of the lock knob is made effortless.

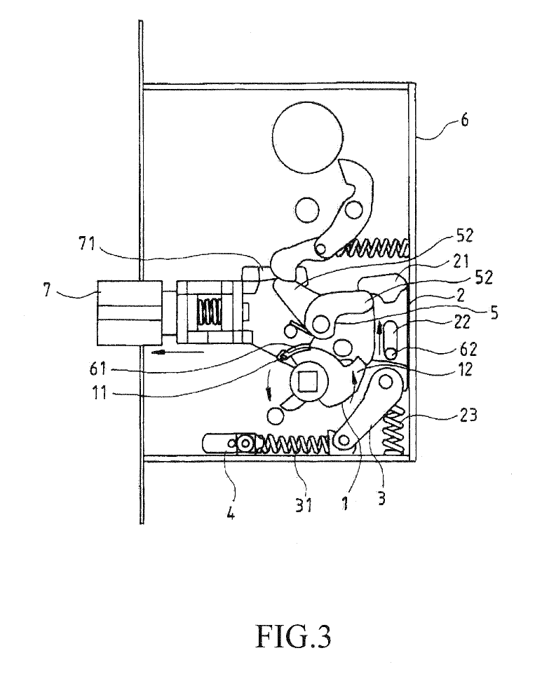

Referring to FIG. 3, which demonstrates a locking operation of the lock according to the present invention, as shown, to lock or close the lock of the present invention, the second hook 52 of the hook member 5 drives the projection 21 of the constraining member 2 upward and makes the constraining member 2 sliding upward, whereby the first hook 51 of the hook member 5 forces the latch bolt 7 to extend out of the casing 6 to thereby have the lock secured in a locked condition. Since the springs 23, 31 are respectively arranged at the bottom of the constraining member 2 and between the push bar 3 and the fixing member 4, when the knob axle 1 is rotated, due to the cushioning effect realized through the resiliency of the springs 23, 31, the relative rotation occurring among components will be smooth and easy. Further, due to the resiliency of the springs 23, 31, the rotation of the knob axle 1 can be performed with less effort so that an efficacy of effort saving can be achieved.

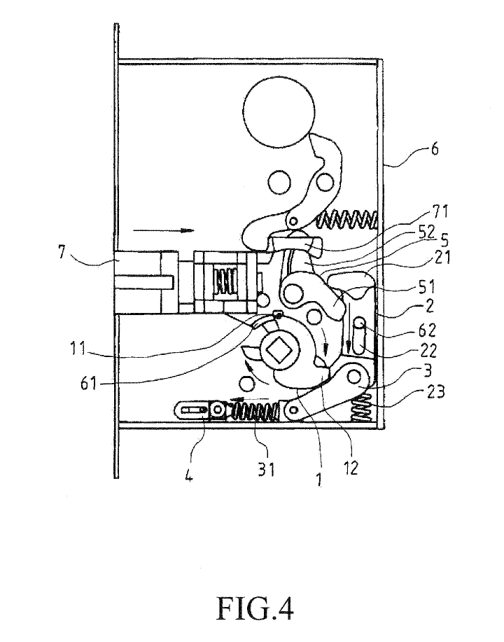

Referring to FIG. 4, which demonstrates an unlocking operation of the lock according to the present invention, as shown, to unlock or open the lock of the present invention, when the knob axle 1 is rotated, the engagement section 12 depresses the push bar 3 down, and the constraining member 2 is thus caused to slide downward, making the projection 21 formed on the top of the constraining member 2 driving the second hook 52 of the hook member 5 to rotate the hook member 5 by an angle, so that the second hook 51 moves rearward in the receiving groove 71 of the latch bolt 7 and the latch bolt 7 is caused to move rearward to unlock the lock. Since the springs 23, 31 are respectively arranged at the bottom of the constraining member 2 and between the push bar 3 and the fixing member 4, when the knob axle 1 is rotated, due to the cushioning effect realized through the resiliency of the springs 23, 31, the relative rotation occurring among components will be smooth and easy. Further, due to the resiliency of the springs 23, 31, the rotation of the knob axle 1 can be performed with less effort so that an efficacy of effort saving can be achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A cushion structure of lock, comprising:
a knob axle, which has an end forming an engagement section that set in engagement with a push bar;
a constraining member, which has a top forming a projection and a bottom to which a first spring is mounted;
the push bar, which is coupled to the constraining member at one end and has an opposite end to which a second spring is mounted, the second spring having an opposite end fixed by a fixing member; and
a hook member, which comprises a first hook and a second hook, the first hook being received in and coupled to a receiving groove defined in a latch bolt, the second hook being set in engagement with the projection of the constraining member;
wherein through properly assembling these components, a cushion structure of lock is formed, whereby when the knob axle is rotated to retract the latch bolt for unlocking, the engagement section depresses the push bar down, and the constraining member is thus caused to slide downward, making the projection formed on the top of the constraining member driving the second hook of the hook member to rotate the hook member by an angle so that the second hook moves the latch bolt rearward to unlock the lock and wherein during the whole process, the resiliency of the springs provides a cushioning effect to the knob axle so that the rotation of lock knob is made effortless.

2. The cushion structure of lock according to claim 1, wherein the knob axle has an opposite end forming a pin, which is received in a slot defined in a casing of the lock, whereby positioning is realized with the pin when the knob axle is rotated.

3. The cushion structure of lock according to claim 1, wherein the constraining member has a surface forming an opening, through which a positioning bar fixed to the casing is received, whereby positioning is realized through the positioning bar when the constraining member slides.
